(19) United States
(12) Patent Application Publication
(10) Pub. No.: US 2024/0410505 A1
(43) Pub. Date: Dec. 12, 2024

(54) FLOW REDUCER INSERT AND COLLIMATOR FOR A TRI-CLAMP HOSE BARB FITTING

(71) Applicant: Avantor Fluid Handling LLC, Devens, MA (US)

(72) Inventor: Tat M. YUEN, Old Bridge, NJ (US)

(73) Assignee: Avantor Fluid Handling LLC, Devens, MA (US)

(21) Appl. No.: 18/738,752

(22) Filed: Jun. 10, 2024

Related U.S. Application Data
(60) Provisional application No. 63/472,145, filed on Jun. 9, 2023.

(51) Int. Cl. F16L 33/035; F16L 33/18; F16L 33/28; F16L 55/027

(52) U.S. Cl. CPC F16L 33/035; F16L 33/18; F16L 33/28; F16L 55/02727; F16L 2201/44

(57) ABSTRACT

A connector assembly includes a main body having a fluid conduit extending therethrough. The connector assembly further includes a flow reducer insert positioned in the fluid conduit, and the flow reducer insert includes a plurality of channels defining flow paths through the conduit. The connector assembly further includes a collimator coupled to the main body, and the collimator includes a plurality of holes configured to provide a substantially columnated flow path.

### CROSS-REFERENCE TO RELATED APPLICATION

This application is related to and claims priority from U.S. Provisional Application No. 63/472,145 filed Jun. 9, 2023, the disclosure of which is incorporated herein by reference in its entirety.

### FIELD OF THE DISCLOSURE

The present disclosure relates to the field of mechanical connectors, and in particular to connectors for use in fluid processing machinery or other applications used in a sterilized environment.

### BACKGROUND OF THE DISCLOSURE

Sanitary style flange fittings have been around for decades. For example, steel fittings are used widely in the dairy, pharmaceutical, and biotechnology manufacturing industries.

These flange fittings typically have a hose barb (or nipple) on one side of the fitting for securing a fluid conduit, such as a flexible hose or tube. On the other side of the fitting, a flange to make a connection with another fluid conduit or piece of equipment is usually found. Using this design, the other fluid conduit or pieces of equipment would also need to have a matching flange in order to make the proper and effective connection.

However, the biotech and pharmalogical manufacturing industry has been moving away from these steel process systems and embracing what are commonly referred to as “single-use” systems, such as those made from disposable plastic parts and rubber tubing. These “single-use” systems are extremely varied, highly customized, and built to the end-user's specifications for a broad range of manufacturing applications.

An example of a single-use sanitary flange fitting can be found in U.S. Pat. No. 6,893,428 (“the '428 patent”), the entire disclosure of which is incorporated by reference herein as if set forth in its entirety. As described in the '428 patent, an over-wrap bag is attached to a flange formed near the middle of the connector. The over-wrap bag maintains the sterility of the enclosed end of the connector. The other end of the connector is typically attached to a piece of tubing or conduit in communication with another larger bag, which has been rendered sterile collectively with the connector. Sterile fluids pumped into the bag, either though the connector itself, or through some other opening in the larger bag, will not be contaminated.

In use, the flange fitting is intended to make a connection with another flange fitting. To make the connection, a flat rubber gasket is placed between the face of the fittings. The gasket is designed to seat into the contours of the fitting face. The flange faces are pushed together (with the gasket in between) and a circular clamp is positioned around the circumference of flanges. The clamp has a swing-bolt that, once secured in place, permits the installer to tighten the two flange faces together and compress the gasket. Once connected, the two fittings form a fluid conduit relatively free from dead-spots and capable of handling substantially high pressures.

However, a drawback to these sterile flange fittings involves the installation of the gasket during connection. For example, the operator making the connection must hold the gasket in place, while at the same time align the flange faces and install the clamp around the fittings and gasket. This is a cumbersome process and prone to contamination.

An example of a connector assembly that addresses the issues described above can be found in U.S. Pat. No. 7,950,700 (“the '700 patent”), the entire disclosure of which is incorporated by reference herein as if set forth in its entirety. The connector assembly includes a connector fitting and a gasket that are secured via an appendage and a receiving component. The gasket may be sterilized together with the fitting, which may eliminate the need for physically handling and positioning the gasket for proper sealing and compression.

However, such connector fittings typically include a fluid conduit having a initial tapered chamber followed by a non-tapered chamber, which increases pressure as the fluid flows through the conduit and out of the end of the fitting. Also, as the fluid flow exits the conduit, the flow spreads radially outward, which can be problematic in certain cases, such as by introducing turbulence into the exhaust flow or otherwise deviating from a smooth axial fluid flow. Therefore, a need exists for a device, mechanism and method for connector assemblies with improved flow characteristics.

### SUMMARY OF THE DISCLOSURE

In one aspect, an embodiment of the present invention relates to a connector assembly including a main body having a fluid conduit extending therethrough. The connector assembly further includes a flow reducer insert positioned in the fluid conduit, and the flow reducer insert includes a plurality of channels defining flow paths through the conduit. The connector assembly further includes a collimator coupled to the main body, and the collimator includes a plurality of holes configured to provide a substantially columnated flow path.

In some embodiments, the flow reducer insert includes a first end portion, a second end portion, and a center portion coupling the first end portion to the second end portion, the first end portion including at least one first channel of the plurality of channels, and the second end portion including at least one second channel of the plurality of channels

In certain embodiments, the fluid conduit includes a tapering first chamber and a substantially uniform diameter second chamber, the first end portion and the center portion of the flow reducer insert are positioned in the tapering first chamber and the second end portion is positioned in the uniform diameter second chamber.

In some embodiments, the first end portion of the flow reducer insert includes a tapered section.

In certain embodiments, the center portion forms an inner cavity in the fluid conduit in which fluid collects.

In some embodiments, the connector assembly further includes a gasket coupled to the main body, the gasket having a central hole aligned with the fluid conduit, and the flow reducer insert is positioned in the central hole of the gasket.

In certain embodiments, the main body includes a first end and a second end, the gasket is positioned at the first end of the main body, and the collimator is positioned at the second end of the main body.

In some embodiments, the collimator includes a screen defining the plurality of holes and a plurality of arms coupled to the screen, and the plurality of arms couple the collimator to the main body.

In certain embodiments, the main body further includes a barbed portion, and the collimator snaps to the barbed portion via the plurality of arms.

In another aspect, an embodiment of the present invention relates to a connector assembly including a main body having a fluid conduit extending therethrough, the fluid conduit having a tapering first chamber and a substantially uniform diameter second chamber. A flow reducer insert is positioned in the fluid conduit, and the flow reducer insert includes a first end portion, a second end portion, and a center portion. The first end portion is positioned in the tapering first chamber of the fluid conduit, and the first end portion includes at least one first channel of a plurality of channels defining flow paths through the fluid conduit. The second end portion is positioned in the uniform diameter second chamber of the fluid conduit, and the second end portion includes at least one second channel of the plurality of channels defining flow paths through the fluid conduit. The center portion couples the first end portion to the second end portion and is positioned in the tapering first chamber of the fluid conduit, and the center portion forms an inner cavity in the fluid conduit in which fluid collects.

In some embodiments, the main body further includes a first end and a second end, and the connector assembly further includes a gasket positioned at the first end of the main body.

In certain embodiments, the gasket includes a central hole aligned with the fluid conduit, and the first end portion of the flow reducer insert is positioned in the central hole of the gasket.

In some embodiments, the connector assembly further includes a collimator coupled to the second end of the main body, and the collimator includes a plurality of holes configured to provide a substantially columnated flow path.

In yet another aspect, an embodiment of the present invention relates to a connector assembly including a main body, the main body having a fluid conduit extending therethrough and including a first end and a second end. A gasket is coupled to the main body at the first end, and a collimator is coupled to the main body at the second end. The collimator includes a plurality of holes configured to provide a substantially columnated flow path.

In some embodiments, the collimator includes a screen defining the plurality of holes and a plurality of arms coupled to the screen, and the plurality of arms couple the collimator to the main body.

In certain embodiments, the main body further includes a barbed portion, and the collimator snaps to the barbed portion via the plurality of arms.

### BRIEF DESCRIPTION OF THE DRAWINGS

For the purpose of illustrating the invention, the drawings show a form of the invention which is presently preferred. However, it should be understood that this invention is not limited to the precise arrangements and instrumentalities shown in the drawings.

FIG. 1A is a top perspective view of a tri-clamp hose barb fitting assembly including a flow reducer insert and collimator according to an embodiment of the present invention.

FIG. 1B is a bottom perspective view of the tri-clamp hose barb fitting assembly of FIG. 1A.

FIG. 2 is a cross sectional view of the tri-clamp hose barb fitting assembly along line 2-2 of FIG. 1A.

FIG. 3 is an inverted perspective view of a flow reducer insert according to an embodiment of the invention.

FIG. 3A is a bottom view of the flow reducer insert of FIG. 3.

FIG. 3B is a top view of the flow reducer insert of FIG. 3.

FIG. 3C is a side view of the flow reducer insert of FIG. 3.

FIG. 4 is a perspective view of a collimator according to an embodiment of the invention.

FIG. 4A is a bottom view of the collimator FIG. 4.

FIG. 4B is a top view of the collimator FIG. 4.

FIG. 4C is a side view of the collimator FIG. 4.

### DETAILED DESCRIPTION OF THE DRAWINGS

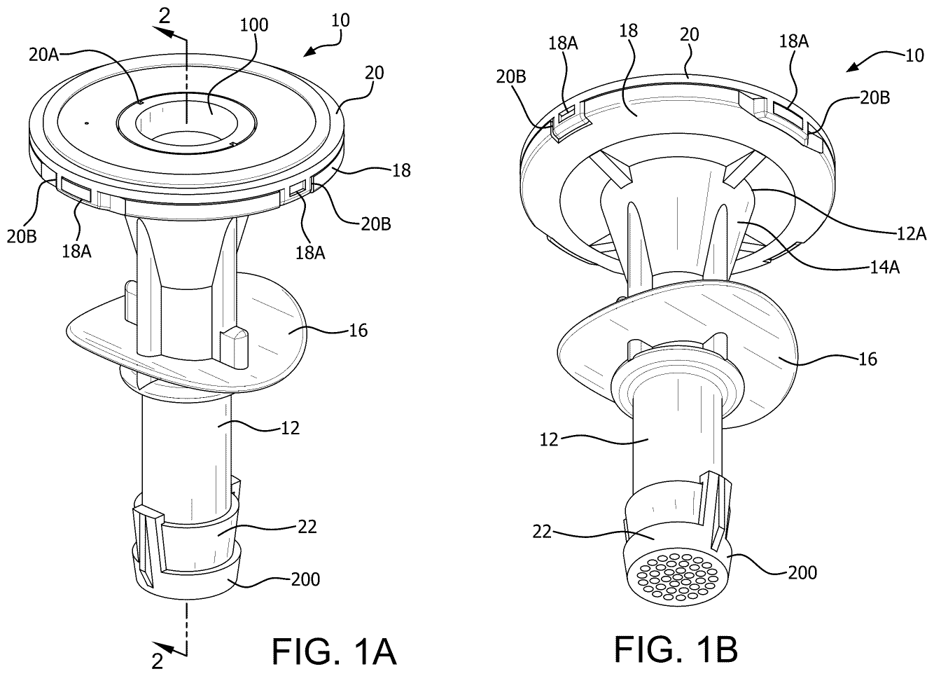

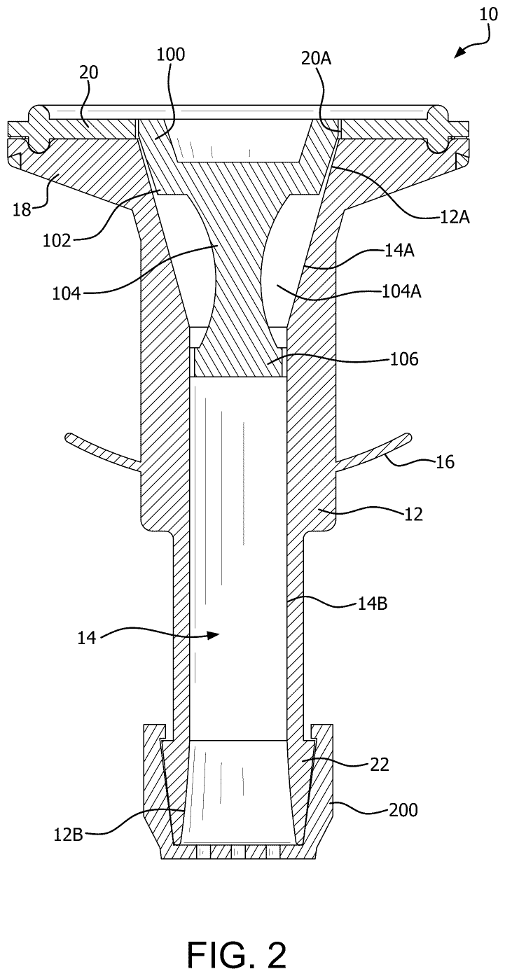

Referring to FIGS. 1A, 1B and 2, a tri-clamp hose barb fitting 10 is shown for use in one embodiment of the invention. A preferred tri-clamp hose barb fitting is sold by Avantor Fluid Handling, LLC under the brand SterilEnz, such as a 2AT-816-TC fitting. The fitting is disclosed in the '700 patent, previously incorporated herein by reference in its entirety.

The fitting 10 includes main body 12 with a first end 12A and a second end 12B on opposite sides of the body 12. A fluid conduit 14 defined by an inner contoured surface of the main body extends through the main body 12 from the first end to the second end. The conduit has two chambers-a first chamber 14A and a second chamber 14B, as will be discussed in more detail. The body 10 and the conduit 14 have a larger diameter at the first end 12A than at the second end 12B. The diameter of the conduit 14 tapers in the first chamber 14A from the first end 12A to the end of the first chamber 14A. The diameter of conduit 14 is preferably substantially uniform, or non-tapering from the end of the first chamber 14A through the second chamber 14B to the second end 12B.

A center flange 16 may extend radially outward from the body 12 at a location between the first end 12A and the second end 12B.

The first end 12A of the body 12 includes an end flange 18 which extends radially outward from the end of the conduit 14. A gasket 20 is preferably attached to the end flange 18. The gasket 20 and end flange 18 are described in more detail in the '700 patent. The gasket 20 as described and illustrated may be made of plastics, polymers, rubber, silicone, EPDM, steel, or any other material or combination of materials that may be manufactured sterile or subsequently sterilized by sterilization methods as understood by those skilled in the art. The gasket 20 includes a central hole 20A that is aligned with and preferably has a diameter the same as the diameter of the conduit 14 at the first end 12A. The gasket 20 also includes appendages 20B that couple to protrusions 18A of the end flange 18 to secure the gasket 20 to the end flange 18.

The second end 12B of the body 12 includes a barbed portion 22 formed on the outer surface of the body 12 for engaging with a hose or other connector fitting in a conventional manner. The barbed portion 22 is an enlarged formation on the outer surface of the body 12 that tapers toward the second end 12B.

As is known in the art, the first end 12A of the fitting 10 is connected to a source of fluid which is configured to channel a pressurized flow of fluid into the first end 12A of the fitting 10. Due to the tapered shape of the conduit 14 in the first chamber 14A, the pressurization of the fluid flow increases as it flows into the second chamber 14B and out the of the second end 12B.

Also, as the fluid flow leaves the second end 12B, the flow spreads radially outward. This can create a problem in certain cases.

To alleviate these issues, the present invention incorporates a flow constriction or flow reducer insert 100 into and a collimator 200 onto the fitting 10 as discussed below.

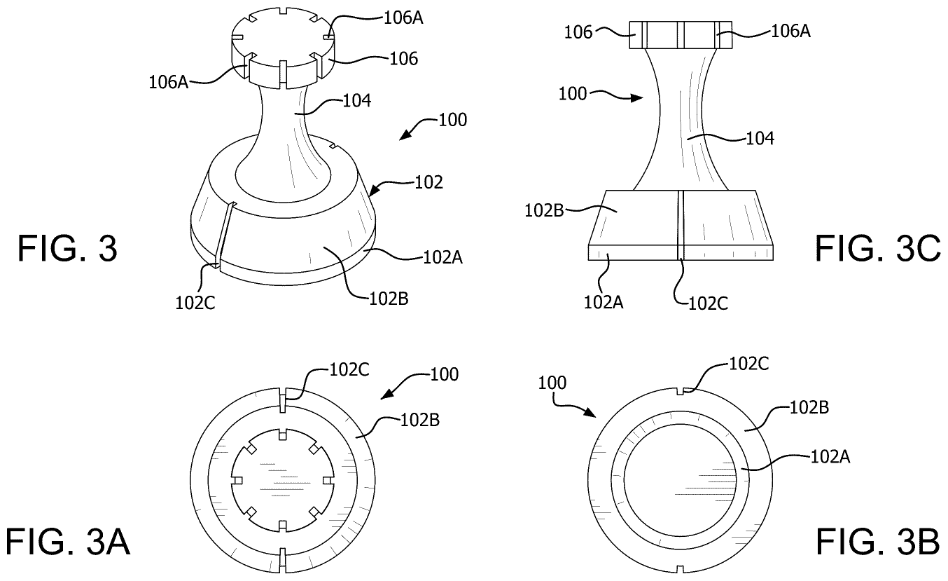

Referring to FIGS. 2, 3, and 3A-3C, the flow constriction insert 100, according to one embodiment of the invention, is shown. The insert 100 includes an upper portion 102, also referred to as a first end portion 102, a center portion 104, and a lower portion 106, also referred to as a second end portion 106. The upper portion 102 includes a top rim 102A that is sized to fit within the center hole 20A of the gasket 20. Extending downward from the rim 102A is a tapered section 102B that has an outer wall that has a taper that is preferably substantially the same as the taper of the upper end of the first chamber 14A such that the tapered section 102B of the upper portion 102 seats against the first chamber 14A thereby preventing of inhibiting flow therebetween into the conduit 14. At least one and more preferably at least two upper channels 102C, also referred to as first channels 102C, are formed in the upper portion 102 defining initial fluid flow paths into the conduit 14. Apart from the upper channels 102C, the upper portion 102 provides a first restriction on the flow into the conduit 14. The number and size of the upper channels 102C can be varied depending on the degree of flow restriction desired.

The center portion 104 of the insert 100 has a dimension that is narrower than the upper portion 102 such that the center portion 104 is spaced radially inward from the wall of the first chamber 14A. This forms an inner cavity 104A in which the fluid that flows through the upper channels 102C can collect.

The lower portion 106 has an outer diameter that is preferably slightly larger than the inner diameter of the conduit 14 so as to provide a slight press fit engagement. Specifically, when the insert 100 is seated in the first chamber 14A of the fitting 10, the lower portion 106 is located in an upper end of the second chamber 14B. Thus, the lower portion 106 inhibits flow of fluid from the inner cavity 104A into the second chamber 14B of the conduit. A plurality of channels 106A, referred to as lower channels 106A or second channels 106A, are formed about the periphery of the lower portion 106, thus providing a flow path for fluid to pass from the inner cavity 104A into the second chamber 14B. The number and size of the lower channels 106A can be varied depending on the degree of flow restriction desired. As should be apparent the lower portion 106 functions to control the flow of fluid into the second chamber 14B thus defining a second flow constriction.

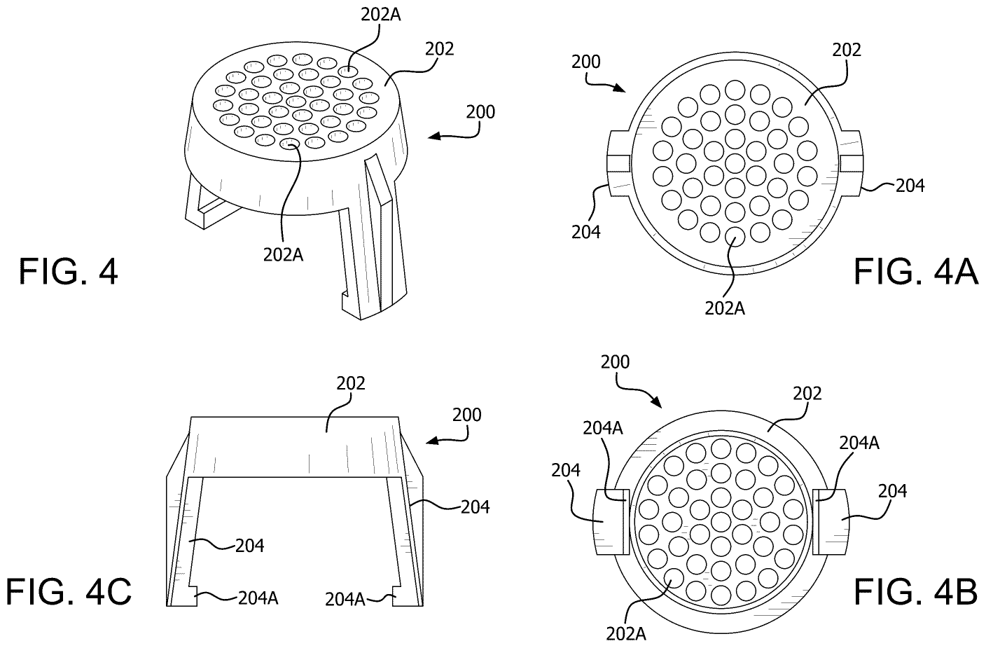

Referring now to FIGS. 2, 4 and 4A-4C, an embodiment of the collimator 200 is shown. The collimator 200 provides directional control over the fluid exiting out of the second chamber 14B of the fitting 10. The collimator 200 includes a screen 202 that is configured to cover the opening of the conduit 14 on the second end 12B of the body 12. The screen 202 includes a plurality of small holes 202A that are configured to cause the flow that passes out of the conduit 14 to flow in a substantially columnated path (i.e., a series of parallel flows). The number and size of the holes 202A can be varied depending on the pressure of the flow.

To attach the collimator 200 to the fitting 10, the collimator 200 includes at least two arms 204 that are attached to or formed integral with the screen 202. The arms 204 extend away from the screen 202 and have a length that is sufficient for a lip 204A on each arm 204 to engage the top end of the barbed portion 22 when the screen 202 is flush against the second end 12B of the body 12. The collimator 200 is, thus, designed to snap onto the barbed portion 22 on the second end 12B of the body 12, thereby securing the collimator 200 to the fitting 10.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The particular implementations shown and described herein are illustrative examples of the invention and are not intended to otherwise limit the scope of the invention in any way. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the invention.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it were individually recited herein.

Terms such as “about” or “approximately”, unless otherwise defined or restricted in the specification, should be understood to define a variance of plus or minus 5%-10% to the numerical term referred to.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed. The various embodiments and elements can be interchanged or combined in any suitable manner as necessary.

The use of directions, such as forward, rearward, top and bottom, upper and lower are with reference to the embodiments shown in the drawings and, thus, should not be taken as restrictive. Reversing or flipping the embodiments in the drawings would, of course, result in consistent reversal or flipping of the terminology.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. A connector assembly comprising:
a main body comprising a fluid conduit extending therethrough;
a flow reducer insert positioned in the fluid conduit, the flow reducer insert comprising a plurality of channels defining flow paths through the conduit; and
a collimator coupled to the main body, the collimator comprising a plurality of holes configured to provide a substantially columnated flow path.

2. The connector assembly of claim 1, wherein the flow reducer insert comprises a first end portion, a second end portion, and a center portion coupling the first end portion to the second end portion, the first end portion comprising at least one first channel of the plurality of channels, and the second end portion comprising at least one second channel of the plurality of channels.

3. The connector assembly of claim 2, wherein the fluid conduit comprises a tapering first chamber and a substantially uniform diameter second chamber, the first end portion and the center portion of the flow reducer insert are positioned in the tapering first chamber and the second end portion is positioned in the uniform diameter second chamber.

4. The connector assembly of claim 2, wherein the first end portion of the flow reducer insert comprises a tapered section.

5. The connector assembly of claim 2, wherein the center portion forms an inner cavity in the fluid conduit in which fluid collects.

6. The connector assembly of claim 1, further comprising a gasket coupled to the main body, the gasket comprising a central hole aligned with the fluid conduit, and the flow reducer insert positioned in the central hole of the gasket.

7. The connector assembly of claim 6, wherein the main body comprises a first end and a second end, the gasket is positioned at the first end of the main body, and the collimator is positioned at the second end of the main body.

8. The connector assembly of claim 7, wherein the collimator comprises a screen defining the plurality of holes and a plurality of arms coupled to the screen, the plurality of arms coupling the collimator to the main body.

9. The connector assembly of claim 8, wherein the main body further comprises a barbed portion, and the collimator snaps to the barbed portion via the plurality of arms.

10. A connector assembly comprising:
a main body comprising a fluid conduit extending therethrough, the fluid conduit comprising a tapering first chamber and a substantially uniform diameter second chamber;
a flow reducer insert positioned in the fluid conduit, the flow reducer insert comprising:
a first end portion positioned in the tapering first chamber of the fluid conduit, the first end portion comprising at least one first channel of a plurality of channels defining flow paths through the fluid conduit;
a second end portion positioned in the uniform diameter second chamber of the fluid conduit, the second end portion comprising at least one second channel of the plurality of channels defining flow paths through the fluid conduit; and
a center portion coupling the first end portion to the second end portion and positioned in the tapering first chamber of the fluid conduit, the center portion forming an inner cavity in the fluid conduit in which fluid collects.

11. The connector assembly of claim 10, wherein the main body further comprises a first end and a second end, and further comprising a gasket positioned at the first end of the main body.

12. The connector assembly of claim 11, wherein the gasket comprises a central hole aligned with the fluid conduit, and the first end portion of the flow reducer insert is positioned in the central hole of the gasket.

13. The connector assembly of claim 11, further comprising a collimator coupled to the second end of the main body, the collimator comprising a plurality of holes configured to provide a substantially columnated flow path.

14. A connector assembly comprising:
a main body comprising a fluid conduit extending therethrough, the main body comprising a first end and a second end;
a gasket coupled to the main body at the first end; and
a collimator coupled to the main body at the second end, the collimator comprising a plurality of holes configured to provide a substantially columnated flow path.

15. The connector assembly of claim 14, wherein the collimator comprises a screen defining the plurality of holes and a plurality of arms coupled to the screen, the plurality of arms coupling the collimator to the main body.

16. The connector assembly of claim 15, wherein the main body further comprises a barbed portion, and the collimator snaps to the barbed portion via the plurality of arms.
